(19) United States
(12) Patent Application Publication
(10) Pub. No.: US 2025/0178749 A1
(43) Pub. Date: Jun. 5, 2025

(54) RECONCILIATION SECURITY METHOD AND SYSTEM

(71) Applicant: The Government of the United States of America, as represented by the Secretary of Homeland Security, Washington, DC (US)

(72) Inventors: Michael Benedetti, Corinth, TX (US); Mark Griffin, Corinth, TX (US)

(73) Assignee: The Government of the United States of America, as represented by the Secretary of Homeland Security, Washington, DC (US)

(21) Appl. No.: 18/969,723

(22) Filed: Dec. 5, 2024

Related U.S. Application Data
(60) Provisional application No. 63/606,416, filed on Dec. 5, 2023.

(51) Int. Cl. B64F 1/36; B64D 45/00; G06K 19/06; G06T 7/00

(52) U.S. Cl. CPC B64F 1/368; G06Q 50/265; G06T 7/0002; G06K 19/06028; G06T 2207/10081

(57) ABSTRACT

Embodiments are directed toward a system and method relating to reconciliation security. A method for reconciliation includes determining, by a controller executing a Passenger to Bag Reconciliation (PBR) application, that a passenger of an international flight has failed to board a plane within an allotted time. A display device shows bag information, including Passenger Name Record (PNR), bag tag number(s), and other associated screening information. Bag Auto ID Transfer (BAIT) function recalls a bag image displayed on a Secondary Viewing Station (SVS) for TSO review. Based on the TSO's review of the bag image, a Bag Process Message (BPM) is updated to reflect that the bag is clear or not clear to fly without the passenger. Responsive to receiving, from the carrier, an indication that the bag has been pulled from the aircraft, the DCS sends a Baggage Unload Message (BUM) to the Automated Baggage System (ABS).

### CROSS-REFERENCE TO RELATED APPLICATIONS

This application is a non-provisional application that claims the benefit of priority from U.S. Provisional Application No. 63/606,416, entitled “Method of Passenger to Bag Reconciliation,” filed on Dec. 5, 2023, the content of which is incorporated herein by reference in its entirety.

### STATEMENT OF GOVERNMENT INTEREST

The claimed subject matter was made by one or more employees of the United States Department of Homeland Security in the performance of official duties. The Government has certain rights in the invention.

### FIELD

The present subject matter relates generally to the field of airline security, and more specifically to the field of baggage reconciliation.

### BACKGROUND

Positive Passenger Bag Match (PPBM) is a regulation of TSA for all air carriers operating international flights. Under PPBM, if a passenger fails to board a flight, the checked baggage associated with that reservation must be removed from the airplane. The time to locate and remove the baggage frequently results in delayed flights, causing a cascading effect on downstream connections.

### SUMMARY

In an example embodiment, a reconciliation system includes a controller executing a Passenger to Bag Reconciliation (PBR) application residing on a display device to determine that a passenger of an international flight has failed to board a plane within an allotted time The display device is further configured to populate a display device with bag information for a bag, including Passenger Name Record (PNR), bag tag number(s), and other associated screening information for eligible bags that qualify for reconciliation. The display device initiates, responsive to selecting a bag from the display device, Bag Auto ID Transfer (BAIT) function to recall, based on the bag information, the bag image for the bag. A Secondary Viewing Station (SVS) is configured to display the bag image that was recalled for TSO review. The display device is further configured to, responsive to receiving, based on the TSO's review of the bag image, an indication from the TSO that the bag is clear, update a Bag Process Message (BPM) for the bag to reflect that the bag is clear to fly without the passenger. Responsive to receiving, based on a review by the TSO of the bag image for the bag, an indication from the TSO that the bag is non-clear, the display device updates the BPM for the bag to reflect that the bag is not clear to fly without the passenger. Responsive to receiving, from the carrier, an indication that the bag has been pulled from the aircraft, Departure Control System (DCS) sends the Baggage Unload Message (BUM) to the Automated Baggage System (ABS).

In another example embodiment, a method for reconciliation includes determining, by a controller executing a Passenger to Bag Reconciliation (PBR) application residing on a display device, that a passenger of an international flight has failed to board a plane within an allotted time. The display device populates with bag information for a bag, including Passenger Name Record (PNR), bag tag number(s), and other associated screening information for eligible bags that qualify for reconciliation. Responsive to selecting a bag from the display device, a Bag Auto ID Transfer (BAIT) function is initiated to recall, based on the bag information, the bag image for the bag. A Secondary Viewing Station (SVS) displays the bag image that was recalled for TSO review. Responsive to receiving, based on the TSO's review of the bag image, an indication from the TSO that the bag is clear, a Bag Process Message (BPM) is updated for the bag to reflect that the bag is clear to fly without the passenger. Responsive to receiving, based on a review by the TSO of the bag image for the bag, an indication from the TSO that the bag is non-clear, the BPM for the bag is updated to reflect that the bag is not clear to fly without the passenger. Responsive to receiving, from the carrier, an indication that the bag has been pulled from the aircraft, Departure Control System (DCS) sends the Baggage Unload Message (BUM) to the Automated Baggage System (ABS).

Other features and aspects will become apparent from the following detailed description, which taken in conjunction with the accompanying drawings illustrate, by way of example, the features in accordance with embodiments of the claimed subject matter. This summary is not intended to identify key or essential features of the claimed subject matter, nor is it intended to limit the scope of the claimed subject matter, which is defined solely by the claims attached hereto.

### BRIEF DESCRIPTION OF THE DRAWINGS

One or more example embodiments of the subject matter are described in detail with reference to the following drawings. These drawings are provided to facilitate understanding of the present subject matter and should not be read as limiting the breadth, scope, or applicability thereof. For purposes of clarity and ease of illustration, these drawings are not necessarily made to scale.

FIG. 1 illustrates a diagram of Passenger Bag Reconciliation (PBR) Screening Operational Assessment Process according to an embodiment.

FIG. 2 illustrates a BSI Context according to an embodiment.

FIG. 3 illustrates Secondary Viewing Stations (SVS) positions installed in an OSARP room according to an embodiment.

FIG. 4 is a display of PBR requested bags according to an embodiment.

FIG. 5 is a display of PBR requested bags including a barcode and unique identifier according to an embodiment.

FIG. 6 is a display of PBR requested bags including a barcode, unique identifier, and selected Cleared bag status indicator according to an embodiment.

FIG. 7 is a display of PBR requested bags including a barcode, unique identifier, and selected No Image bag status indicator according to an embodiment.

FIG. 8 is a display of PBR requested bags including a barcode, unique identifier, and selected Not Cleared bag status indicator according to an embodiment.

FIG. 9 is a display of scan history including example messages according to an embodiment.

FIG. 10 is a display of scan history including other example messages according to an embodiment.

FIG. 11 is a display of a summary of bag tags that have undergone PBR screening according to an embodiment.

FIG. 12 illustrates Host Reservation/Departure Control System according to an embodiment.

FIG. 13 illustrates Host Reservation/Departure Control System with STIP according to an embodiment.

FIG. 14 illustrates a Process Diagram “Reconciliation,” based on RP 1800 5.4.5, which depicts various components for connectivity with the DCA and ABS according to an embodiment.

FIG. 15 illustrates a flow diagram of host reservation departure control system according to an embodiment.

FIG. 16 illustrates a flow diagram of host reservation departure control system with STIP according to an embodiment.

FIG. 17 illustrates screening information associated with sample passengers according to an embodiment.

FIG. 18 illustrates screening information associated with sample passengers, with a first bag selected according to an embodiment.

FIG. 19 illustrates screening information associated with sample passengers, with a bag determined to have a clear status according to an embodiment.

FIG. 20 illustrates screening information associated with sample passengers, with a bag determined to have a non-clear status according to an embodiment.

FIG. 21 illustrates screening information associated with sample passengers, with a bag determined to have a pending status according to an embodiment.

FIG. 22 illustrates screening information associated with sample passengers, with a bag determined to have a removed status according to an embodiment.

FIG. 23 illustrates an EDS network according to an embodiment.

FIG. 24 illustrates a bag security landing page according to an embodiment.

FIG. 25 illustrates bag flagging according to an embodiment.

FIG. 26 illustrates a flowchart of the PBR screening process according to an embodiment.

FIG. 27 illustrates a flowchart of a PBR screening process according to an embodiment.

These drawings are not intended to be exhaustive or to limit the subject matter to the precise form(s) disclosed. It should be understood that the present subject matter can be practiced with modification and alteration, and that the subject matter is limited only by the claims and the equivalents thereof.

### DETAILED DESCRIPTION

Various carriers are requesting plane departure authorization when a passenger who has checked baggage fails to board an aircraft. The proposed capability, Passenger to Bag Reconciliation (PBR), will allow the Transportation Security Administration (TSA) to recall and view computed tomography (CT) bag images for bags whose passengers have not boarded, while not having to share the bag images with the airline carriers. The bag image can be found for any passenger who has failed to board a plane within the allotted time, to determine if the bag is safe to fly without the passenger. Implementing the PBR process allows for the carrier to remain in compliance with TSA policies and with International Air Transport Association (IATA) Recommended Practice 1739-Passenger Reconciliation Procedures. The PBR process ensures airlines are compliant with U.S. regulations enabling the safe and secure departure of an aircraft. PBR utilizes various components from the airline/airport host reservation system, the checked baggage inspection system (CBIS) software, as well as connectivity to the Explosive Detection System (EDS) network to positively match a passenger to their checked baggage in conjunction with the boarding process.

Airport/Airline operations must comply with DHS “Aviation Security Policies,” which can be found in Aviation Security Policy of Homeland Security (dhs.gov). The PBR process can be used by U.S. airlines in airports serving international destinations. Additionally, there are exceptions where some passengers may not be considered for the PBR process. PBR Exceptions include the following: checked baggage associated with a selectee reservation will not be eligible for PBR due to risk level (airlines are prohibited from presenting selectee baggage); any bag that fails to present an image (image unavailable) will be marked for removal; and any transfer baggage (originating at another airport) will not have an EDS image and will not be eligible for PBR. This PBR process determines if a bag is, or is not, allowed to travel if a passenger fails to board an aircraft. The process can use various aspects to make this determination, including but not limited to: the departure is from a US airport; the bag has been screened using EDS equipment and allows for the appropriate recall of the image; the bag image is individually reviewed, evaluated, and cleared by TSA; any bag escalated to Non-CLEAR is required to be off-loaded and manually inspected by a TSA agent; and the carrier shall be responsible to relay to TSA, manually or automatically, that the bag in question has been positively removed.

The following is a list of acronyms used herein:
ABS=Automated Baggage System (ABS)
AODB=Airport Operational Database (AODB)—a centralized database system that allows airports to store, manage, and distribute real-time operational data crucial for their day-to-day activities.
ATR=Automatic Tag Reader (ATR)
BHS=Baggage Handling System (BHS)
BPM=Baggage Processed Message, Bag Process Message (BPM)
BSI=Baggage System Interface (BSI)
BSM=Bag Status Message (BSM)
BUM=Baggage Unload Message (BUM)
Cat X or CAT-X=Category X that designates the largest and busiest airports in the U.S. as measured by volume of passenger traffic, that require the highest level of security measures due to their significant passenger and cargo traffic. In 2002 the TSA revealed the 21 Category X airports.
CBCM=Checked Baggage Capability Management (CBCM)
CBRA=Checked Baggage Reconciliation Area
CONOPS=Concept of Operations
DCS=Departure Control System, which automates processing an airline's airport management operation, which includes managing the information required for airport check-in, printing boarding cards, baggage acceptance, boarding, load control and aircraft checks. Today, DCS mostly (98%) manage e-tickets using interfaces from a number of devices, including check-in kiosks, online check-in, mobile boarding cards, and baggage handling.
EBS=external business system (EBS)
EDS=Explosive Detection System (EDS)
ETD=Explosives Trace Detection
FCM=Flight Close Message (FCM)
FIDS=Flight Information Display System
HRS=[Airline] Host Reservation System
IATA=International Air Transport Association
IRD=Integration Requirement Document
ISD=Inline Screening Device
ISSO=Information System Security Officer (ISSO)
OA=Operational Assessments (OA)
OEM=Original Equipment Manufacturer
OSARP=On Screen Alarm Resolution Protocol (OSARP)
OSR=On-Screen Resolution
OSRA=On Screen Resolution Area (OSRA)
PBR=Passenger to Bag Reconciliation (PBR)
PCR=Passenger Clearance Ranking
PGDS=Planning Guidelines and Design Standards
PLC=Programmable Logic Controller
PNR=Passenger Name Record
PPBM=Positive Passenger Bag Match (PPBM) Screening, a regulation required for international travel to remove baggage when a passenger did not board, which delays flights
PPE=Policy, Plans, and Engagement
PSS=Passenger Security Status
RBS=Risk Based Security
RCA=Requirements and Capabilities Analysis (RCA)
RFID=Radio Frequency Identification
SAC=Sortation Allocation Controller—the Baggage System's reporting and sortation computer system that manages flight info, passenger info, and baggage destinations.
SOP=Standard Operating Procedures
SSI=Sensitive Security Information (SSI)
STIP=Security Technology Integrated Program
STSO=Supervisory Transportation Security Officer (STSO)
SVS=Secondary Viewing Station
T&D=Training and Development
TI=Threat Injects
TSA=Transportation Security Administration
TSO=Transportation Security Officer (TSO)
WAN=Wide Area Network

PBR helps airlines comply with IATA resolutions and recommended practices (e.g., outlined in the IATA Passenger Standards Conference Manual found at the following website https://www.iata.org/en/publications/manuals/passenger-services-conference-resolution-manual/), such as the following:

### IATA Resolutions

1) Resolution 745—Dangerous Goods in Passengers' Baggage
   Observe the following with respect to the carriage of dangerous goods in or as passenger-checked or carry-on baggage:
   a) 745a—Acceptance of Firearms and Other Weapons and Small Caliber Ammunition
   b) 745b—Acceptance of Power Driven Wheelchairs or other Battery Powered Mobility Aids as Checked Baggage.
2) Resolution 746—Pooling of Baggage

Where two or more passengers, traveling as one party to a common destination or point of stopover by the same flight, present themselves and their baggage for traveling at the same time and place, they shall be permitted a total baggage allowance equal to the combination of their individual baggage allowances.

To comply with passenger and baggage reconciliation requirements, each passenger of a non-family group should be given their own baggage claim checks.

### IATA Recommended Practices

3) RP 1739—Passenger/Baggage Reconciliation Procedures
   “4.3.1 Each Contracting State shall establish measures to ensure that operators, when providing service from that State, do not transport the baggage of passengers who are not on board the aircraft, unless the baggage is separated from the passenger and is subjected to other security measures.”
a) Refer to Appendix A—Originating Passengers
b) Appendix E—Reconciliation System Assumptions and Various Methods to Associate Passengers to Baggage in Reconciliation Systems
4) RP 1745—Baggage Information Messages
   Members who transmit and receive Baggage Information Messages, including the Baggage Transfer Message (BTM), Baggage Source Message (BSM), Baggage Processed Message (BPM), Baggage Unload Message (BUM), Baggage Not Seen Message (BNS), Baggage Control Message (BCM), Baggage Manifest Message (BMM), and the Baggage Request (BRQ), shall apply the following definitions, formats, and specifications for the creation, transmission, receipt, and interpretation of those messages.
5) RP 1746 Baggage System Interface (BSI)
   Airlines, airports, and system providers adhere to the guidelines set forth below when requiring the exchange of aviation industry messages between an Automated Baggage System and an external business system, like the Departure Control System (DCS), etc.
6) RP 1789 Automated Boarding Control
   Members use the following specifications when planning and implementing an Automated Passenger Boarding Control (ABC).
7) RP 1797c Management Information Systems Interface
   RECOMMENDED that, Members and Handling Agents who provide data to Airport Management Information Systems (MIS) adhere to the following procedures.
8) RP 1800—Automated Baggage Handling based on the IATA License Plate Concept
   a) Section 5.2—Sortation
   b) Section 5.3—Screening
   c) Section 5.4—Reconciliation
   d) Section 5.9—Offloading/Reloading
   e) Section 6—Process Specific Baggage Codes

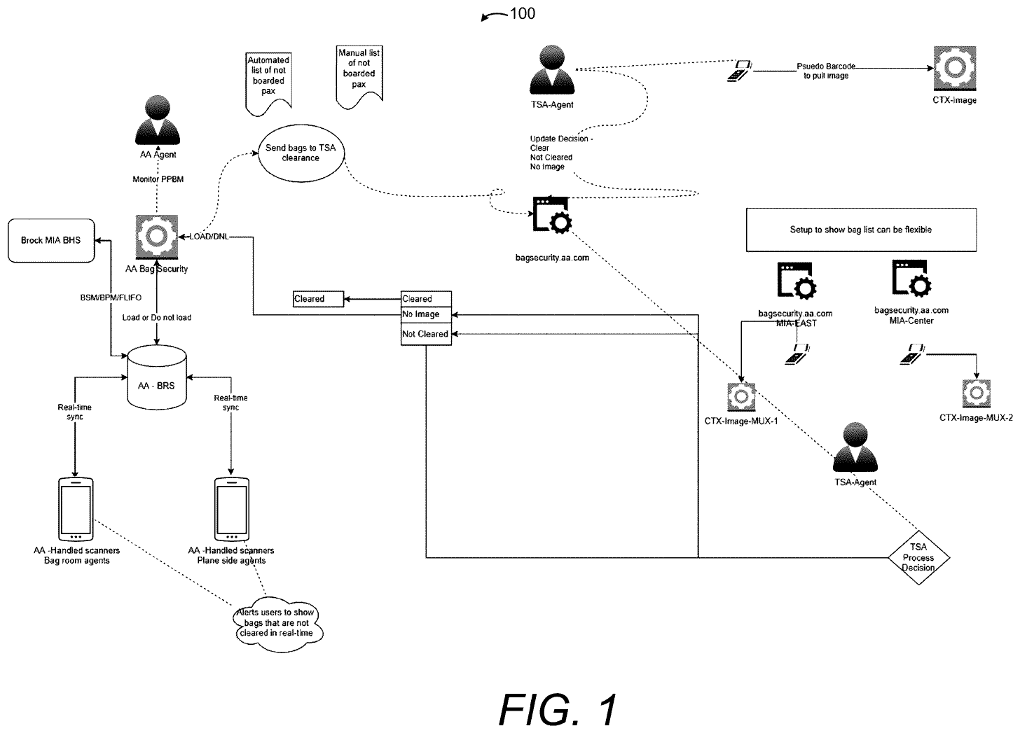

FIG. 1 illustrates a diagram 100 of Passenger Bag Reconciliation (PBR) Screening Operational Assessment Process according to an embodiment. Embodiments described herein include functional and physical design characteristics of data flow processes at the system integration level between, e.g., an airport's Departure Control System (DCS) to Inline Screening Device (ISD) subsystems. Embodiments can interact with implementations of Risk Based Security (RBS), such as: using BHS via the Sortation Allocation Controller (SAC), which is a method currently defined as IATA compliant; using Security Technology Integrated Program (STIP), which can also need SAC RBS data transfer; and using the STIP and the Baggage Handling System (BHS) via the SAC, which is a method that remains International Air Transport Association (IATA) compliant. The Baggage Handling System (BHS) relays the following information to the Airline via the Bag Process Message (BPM): pseudo ID; and TSA Multiplexer (MUX) Area. PBR can be initiated by Airline systems at a predetermined time, for example, 15 minutes prior to departure can be used as an initial baseline.

The PBR process can be supported by hardware and network infrastructure at U.S. CAT-X airports, such as an Automated Baggage System (ABS) or Baggage Handling System (BHS) owned and operated by the airport/airline and which has a connection to the carrier's DCS and TSA's screening equipment. As set forth in IATA Recommended Practice 1746, airlines, airports, and system providers are recommended to adhere to the IATA guidelines for the exchange of aviation industry messages between an ABS and an External Business System (EBS), such as the DCS, AODB, etc. The recommendations provide for a BSI, which is an automated system enabling the exchange of such messages with such systems.

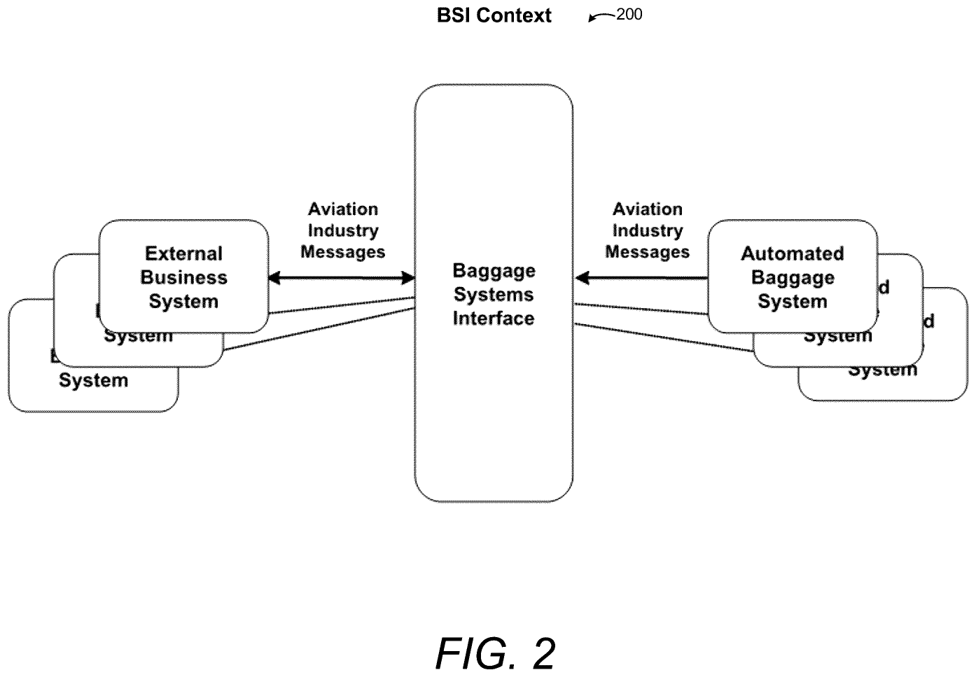

FIG. 2 illustrates a BSI Context 200 according to an embodiment. The messages used by the BSI can pertain to baggage items, flights, containers, resources, and the like. Conceptually, a BSI resembles a message distribution system. The BSI mediates between applications and performs functions such as message transport and routing, communication protocol conversion, and message format conversion. Connections for the BSI can be across a direct wire, across a network, across an Enterprise Service Bus, and the like. The BSI can function as a decoupling mechanism between information systems. The BSI handles the interfacing, and therefore can serve as the decoupling point for EBS and ABS. The BSI provides advantages including flexibility, by handling message format conversions if needed. The BSI can convert the message envelope, while leaving the message payload unconverted as needed. The BSI can provide integrability, by transporting and routing messages between EBS and ABS. The BSI can provide connectivity, by taking care of communication protocol conversions as needed.

In an embodiment, a carrier provides a tablet that transmits and receives data (e.g., passenger and bag tag information) between the gate agent and TSA. The procedure can use other devices, such as laptop computers, desktop computers, kiosks, smartphones, and the like, which are capable of receiving passenger and bag tag information and displaying a barcode with brightness and contrast suitable for scanning. As used herein, the term tablet or PBR tablet may include any such device capable of receiving and displaying data and barcodes or similar for information exchange. In an embodiment, the PBR tablet is not connected to TSA technology. The PBR tablet utilizes Wi-Fi provided by an airline carrier. In an embodiment, the PBR tablet has no “browser” or connectivity to the general internet, because it is connected to an “intranet,” such as the AA Res System provided by American Airlines (AA). In this example with American Airlines, the bag tag information that AA transmits via the tablet is provided by the AA Res System, in the form of a bar code. The transmitted barcode can be the same format of bar code that is used for bag tags, which is a suitable format for scanning by EDS. TSOs frequently scan the bar code on the bag tag to retrieve an EDS image of the bag in the CBRA. Accordingly, for scanning the barcode from the tablet, TSA can utilize existing TSA viewing stations in the OSR and scan guns, emulating the process conducted in the CBRA during regular Level 3 screening involving printed bag tags, but by instead using tablets with digital barcodes displayed on the tablets. The bags subject to PBR screening have already been screened by an Explosive Detection System (EDS) using TSA's certified algorithms, and either cleared by the EDS or by an operator. PBR screening can serve as a secondary measure to that EDS or operator screening process.

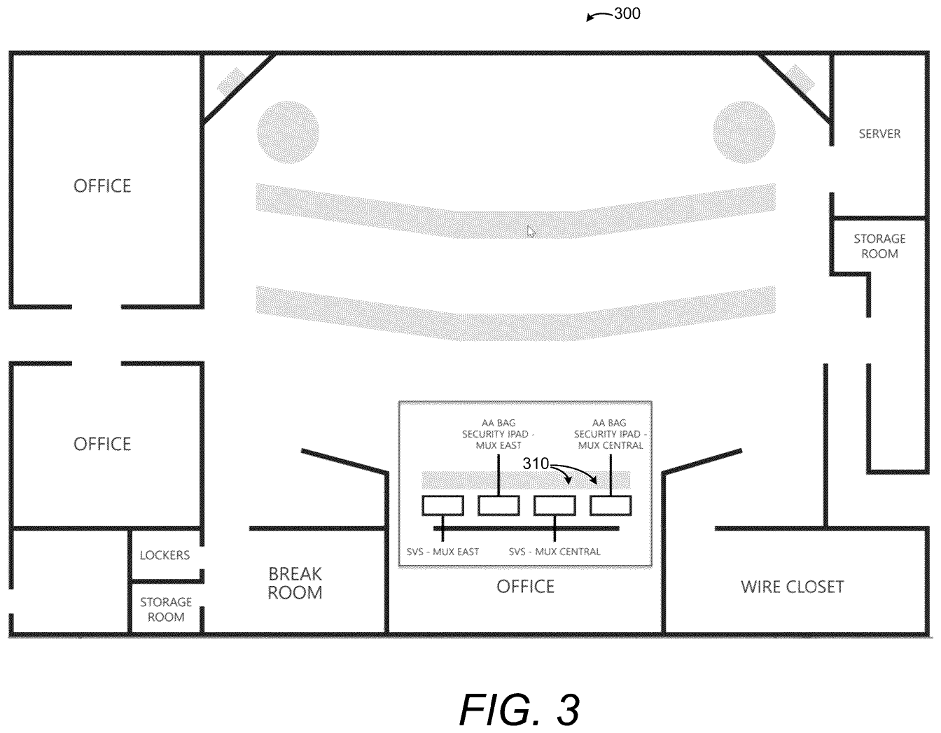

FIG. 3 illustrates Secondary Viewing Stations (SVS) 310 installed in an OSARP room 300 according to an embodiment. In the illustrated embodiment, each SVS 310 is associated with a single MUX network. Each SVS 310 position is assigned an Airlines-provide iPad (portable electronic device) which will run the Airline Bag Security Application. Each such device receives Bag Security information for the MUX network associated with its SVS 310. Upon initiating the PBR for a passenger deemed eligible, the Psuedo ID, Psuedo bar code, and IATA tag information populate on the Bag Security Application screen. The TSO performing the PBR function will scan the first bag on the list which initiates the Bag Auto ID Transfer (BAIT) function where the image is automatically recalled on the Secondary Viewing Station (SVS). Upon review of the bag's image, where the TSO determines the bag to be CLEAR, the TSO will select the “CLEARED” for the bag on the Bag Security Application. No offloading is required, and Airlines Bag Security and RampLink systems will be updated to reflect the bag is clear to fly without the passenger. In an embodiment, software other than RampLink can be part of a carrier's DCS. Such software can be used for loading processes checkoff, which can include bags that are or are not cleared for departure. This also includes indications of which bags are loaded into which specific containers, to assist in identifying where the bag is in the airplane's hold. Upon review of the bag's image, where the TSO determines the bags that are NOT CLEARED, The TSO will select the “NOT CLEARED” for the bag on the Airline Bag Security Application. Offloading of the bag is required and Bag Security and Ramplink Applications will be updated to reflect the bag is NOT CLEARED to fly without the passenger. The carrier will pull the bag and verify in airline Bag Security that the bag has been pulled. Upon review of the bag's image, where the TSO determines the bags do not have an associated image to review, the TSO will select the “NO IMAGE” for the bag on the Airline Bag Security Application. Offloading of the bag is required and Bag Security and Ramplink Applications will be updated to reflect the bag is NOT CLEARED to fly without the passenger. The carrier will pull the bag and verify in airline Bag Security that the bag has been pulled.

For the purposes of the PBR Operational Assessment, bags with NO PSUEDO to IATA traceability or that have otherwise been lost in tracking are not eligible for the PBR process. This will include transfer bags. Airline Bag Security will not include these bags and they will not be presented for TSOs for review. Offloading is required and Bag Security and Ramplink Applications will be updated to reflect the bag is NOT clear to fly without the passenger. The carrier will pull the bag and verify in airline Bag Security that the bag has been pulled.

Special Handling Considerations (Reference IATA RP 1745): Passengers deemed to be traveling with a Selectee status as noted in the “x” element of the BSM will not be eligible for the Operational Assessment of the PBR Operational Assessment. Offloading is required and Bag Security and Ramplink Applications will be updated to reflect the bag is NOT clear to fly without the passenger. The carrier will pull the bag and verify in Airline Bag Security that the bag has been pulled.

Additional Notes for Approved Exceptions for the PBR Operational Assessment: In an embodiment, the initial PBR Operational Assessment is limited to flights for a single market segment. As the Operational Assessment progresses, Airline carriers and TSA can expand the Operational Assessment to additional markets to gather further information or process understanding. For the purposes of the Operational Assessment, Airlines provide TSA a generic login to the Airline Bag Security Application. An embodiment, for the purposes of the Operational Assessment, may not require auto notification of bags awaiting the PBR process. The concept of notification can be used in embodiments of the PBR process.

In an embodiment, the PBR process employs TSOs that have completed all requisite Original Equipment Manufacturer (OEM) Explosive Detection System (EDS) training per current Training and Development (T&D) curriculum and guidelines. While PBR does not need to use On Screen Alarm Resolution Protocol (OSARP) as a resolution, TSOs should be OSARP certified on the applicable EDS in order to resolve images for the PBR process. TSOs will also complete PBR training. Future curriculum development to support PBR may be required and developed as needed.

The PBR process can involve generating data and determining metrics corresponding to various questions and reports. Requirements and Capabilities Analysis (RCA) Checked Baggage Capability Management (CBCM) can collect data provided by the automated PBR software. This data can be provided to CBCM by the airline or BHS contractor. Areas of interest pertaining to the data include: How many bags per day/flight require PBR review? How many bags per day/flight are marked for removal? How often is an image not available for PBR review? How long does the TSO spend resolving image? Operational Impacts? In addition to the automated system reports, local TSA can conduct Threat Injects (TI) of items that both do and do not alarm the EDS. These TIs will validate the effectiveness of the TSO, as well as provide insight of possible effectiveness gains.

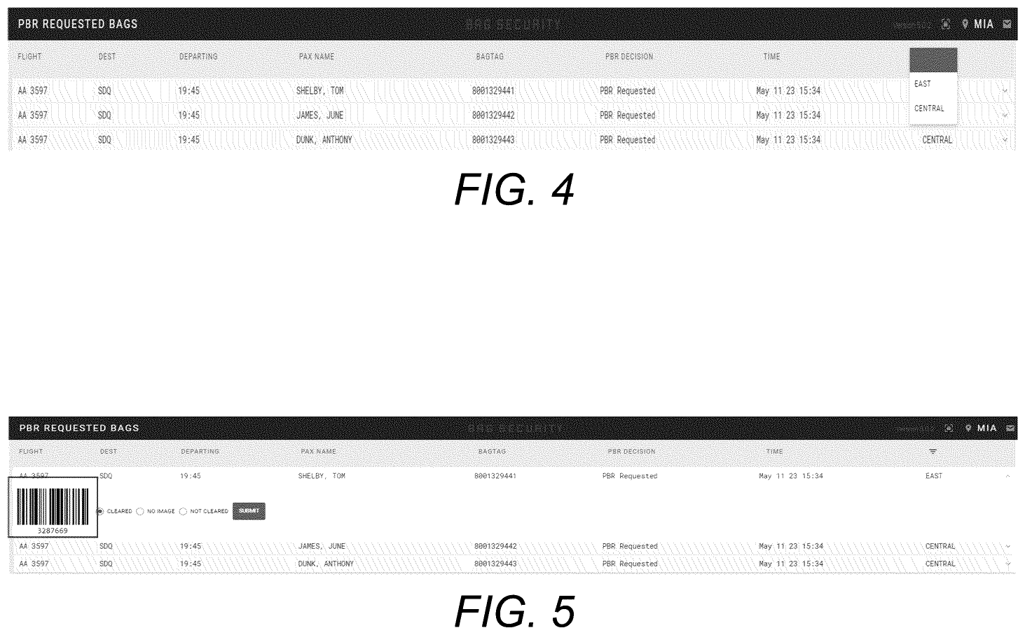

When PBR is initiated (e.g., when the boarding window for a given flight has closed), the airline will send data to TSA for affected baggage which will display on the tablet as shown in FIG. 4 for PBR requested bags. In an embodiment, a notification will be sent to the TSO in the On Screen Resolution Area (OSRA) via a tablet for any checked baggage associated with a passenger who has failed to board the aircraft. TSA will see, on the tablet, a list of bags to be reviewed. A notification will be provided for a given IATA/piece of baggage. The notification can be provided as a message accompanied by audible or visual indicators (e.g., generated by the tablet). The tablet will contain a list of any active PRB passengers who have not been processed. A given bag is associated with a barcode, such as those used for bag tags. The TSO will scan each barcode presented and conduct image review on TSA viewing station. Following image review as described in the PBR OA Standard Operating Procedures (SOP), the TSO will select “cleared” “not cleared” or “no image” on the PBR tablet. Any baggage cleared will remain onboard. Any baggage declared not cleared or no image will be removed by the airline and normal PPBM procedures will apply. If a bag image includes what appears to be an Obvious Threat (regardless of alarm), the PBR process will stop and an STSO will be notified. If the STSO agrees with the Obvious Threat determination, regular Obvious Threat procedures will be followed. Local TSA Regulatory will continue to perform random inspections on international flights to ensure airlines are following proper PPBM and PBR policies are being followed.

As the TSO reviews each item on the list, the item is cleared from the list. Once the screen is clear, there are no active PBR bags. The user can also filter based on East/Central CBIS. The TSO clicks on each row to display the bar code and unique identifier, as shown in FIG. 5. The barcode can be scanned by TSA-provided scan gun (connected to a TSA workstation) as used in the CBRA, enabling the TSA workstation to display the corresponding stored bag image on the TSA viewing station. A barcode corresponds to a passenger's relevant information, such as name, flight data, number “x” of “x” bags, security status, etc. These information fields are defined by IATA standards which carriers are required to abide by (see IATA document standards). TSA will scan the barcode with scanner and review the image in their system. TSA provides, on the PBR tablet, a disposition, and submits the disposition via the PBR tablet to the airline. In the case of tablet malfunction or other issues resulting in a failed message, the bag will not be presented to a TSO and the onus falls back on the carrier and the bag must then be pulled from the aircraft.

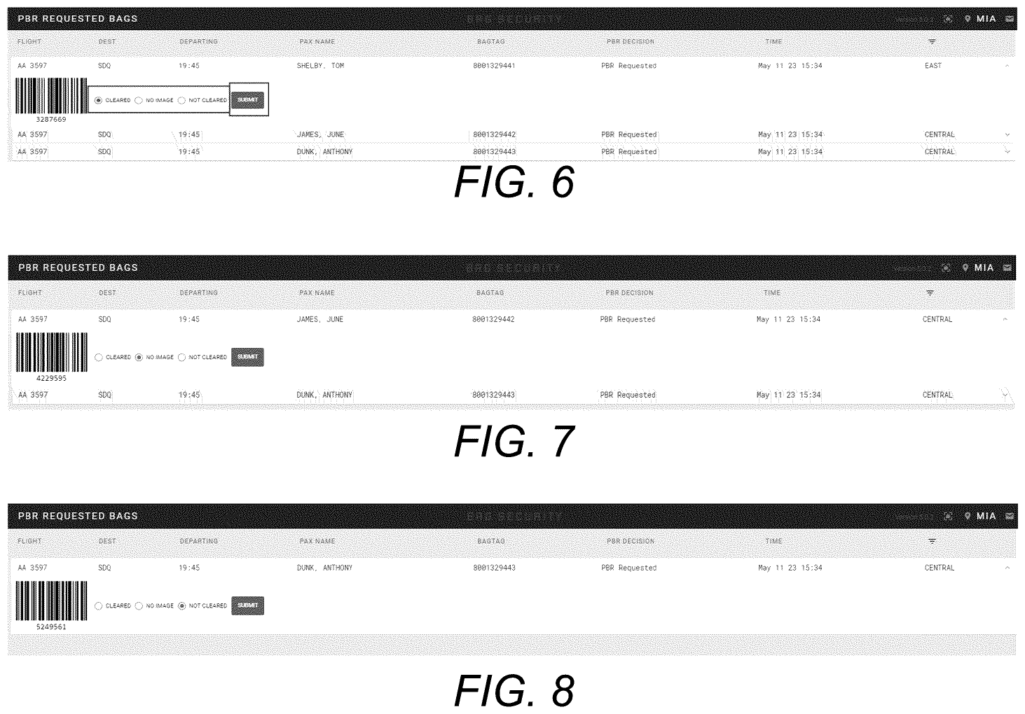

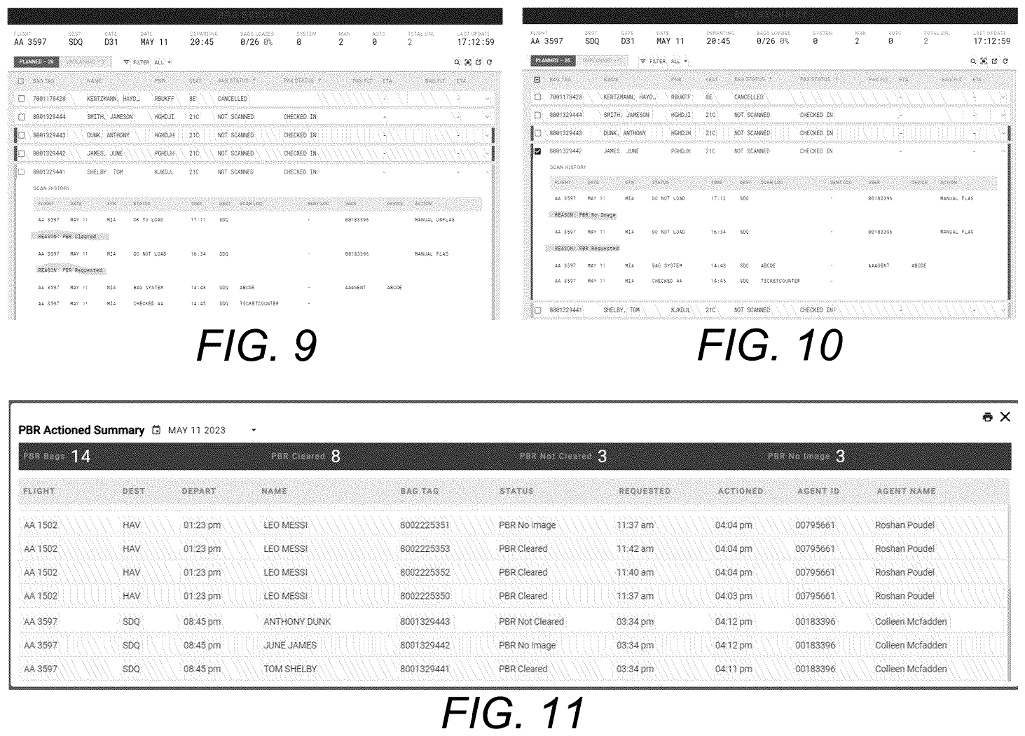

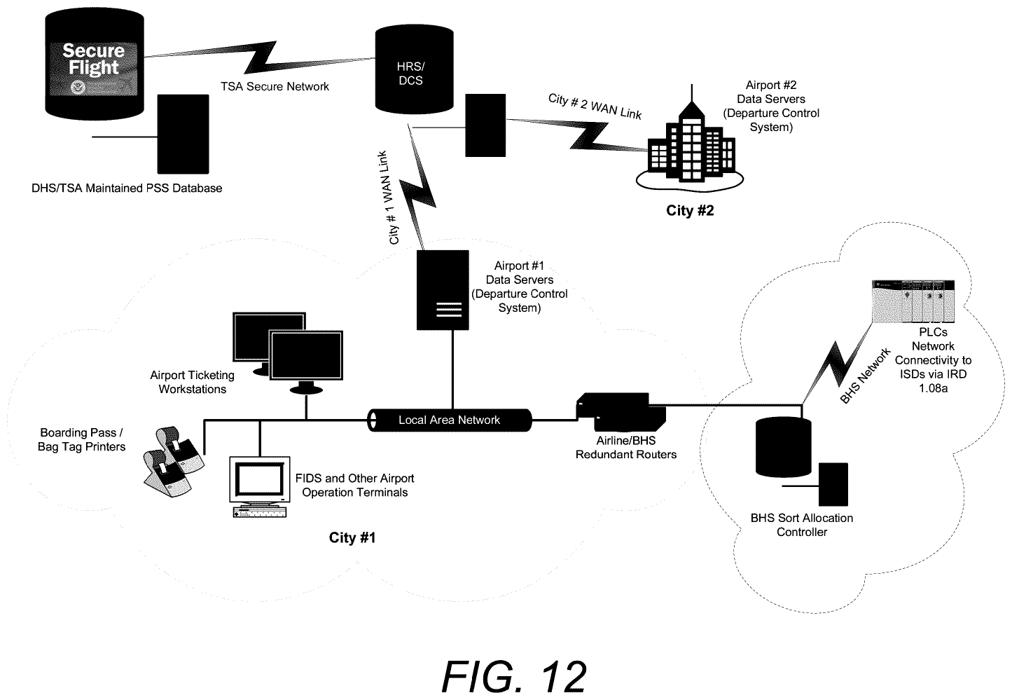

The bag images are not needed to be displayed on the tablets. The bag images are considered Sensitive Security Information (SSI) and not transmitted to the carrier. Rather, the bag images are sent to the TSA system for review on the TSA system, responsive to the TSA system having the barcode scanned. Bag images are screened by the EDS on the TSO's workstation, not on the tablet. The tablet provides a bar code/bag ID that can be used to access the bag image on the workstation. The tablet also allows for selection of bag status indicator, e.g., by the agent selecting an appropriate bag status indicator on the table that corresponds to an outcome of the agent's review of the corresponding bag image. In an embodiment, the agent can manually type or search for a Bag ID (IATA number) to select a corresponding bag image for review. After reviewing the image, the TSO will select a bag status indicator on the tablet, as shown in FIG. 6, which illustrates selection of a cleared status. FIG. 7 illustrates selection of a No Image status, and FIG. 8 illustrates selection of a Not Cleared status. This determination is transmitted to the gate agent responsive to pressing the submit button. The gate agent will receive a message corresponding to the bag status indicator after review is complete. Example messages are shown in FIG. 9 and FIG. 10. FIG. 9 illustrates disposition history for a cleared bag. FIG. 10 illustrates disposition history for a not cleared bag or for a bag that has no image. FIG. 11 is a display of a summary of bag tags that have undergone PBR screening according to an embodiment.

Connections and interfaces, such as those to TSA's screening equipment, can be direct connections or other types of connections. Connection interface design is specified according to TSA's Interface Requirements Document (IRD) 1.08a as well as the EDS integration guide. The connections illustrated in the various Figures are meant to reflect a high-level configuration and may not include all the installed components at a given airport. These existing connections allow for seamless integration between all the necessary components for the successful implementation of the PBR process.

FIG. 12 illustrates Host Reservation/Departure Control System according to an embodiment.

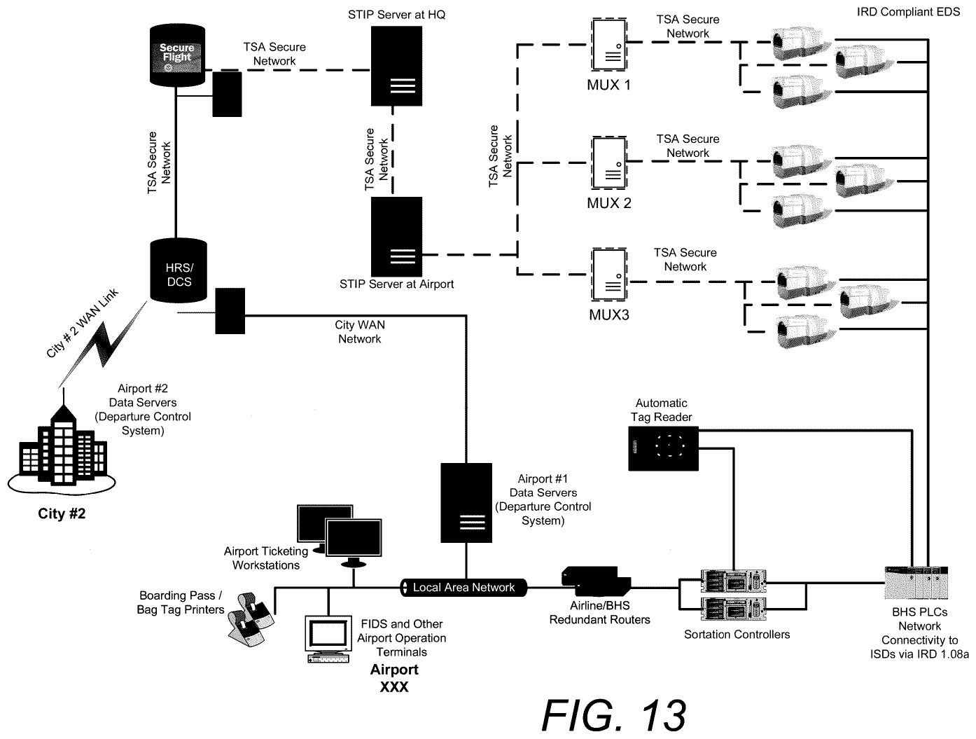

FIG. 13 illustrates Host Reservation/Departure Control System with STIP according to an embodiment. CAT-X airports have infrastructure to support the PBR process, which can involve additional data being processed based on the components outlined in the IATA standards. The Resolutions and Recommended Practices noted above are outlined in the IATA Passenger Standards Conference Manual. Based on the final automated configuration, various other aspects of the Resolutions and Recommended Practices may be used. The illustrated system also includes STIP servers connected to the TSA secure network and located at HQ and the airport.

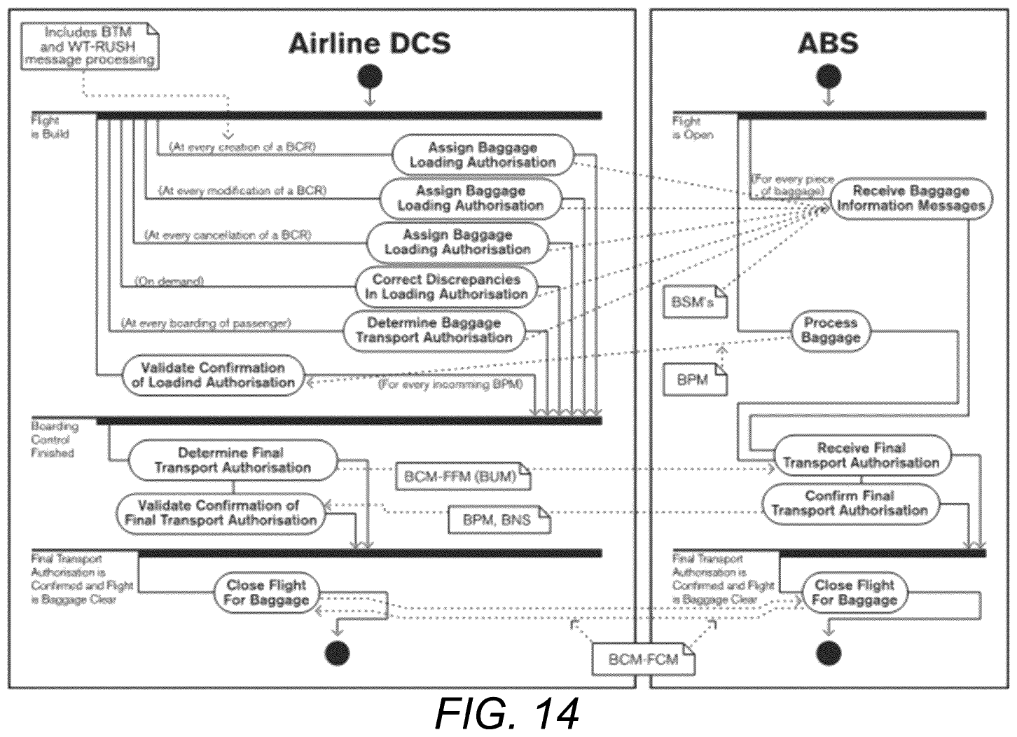

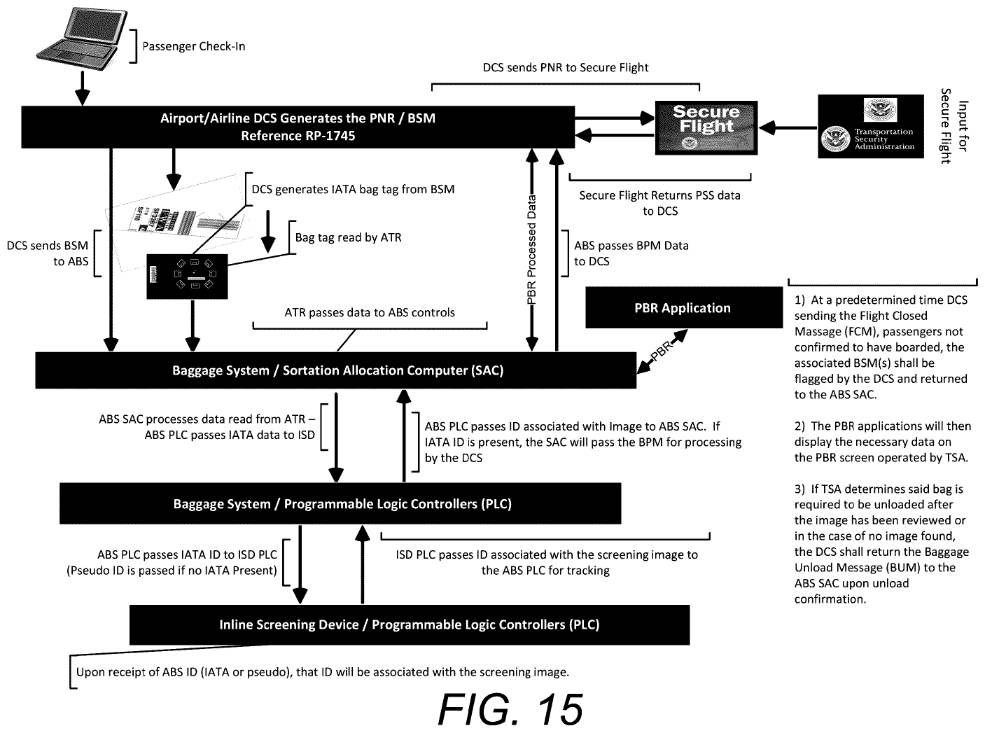

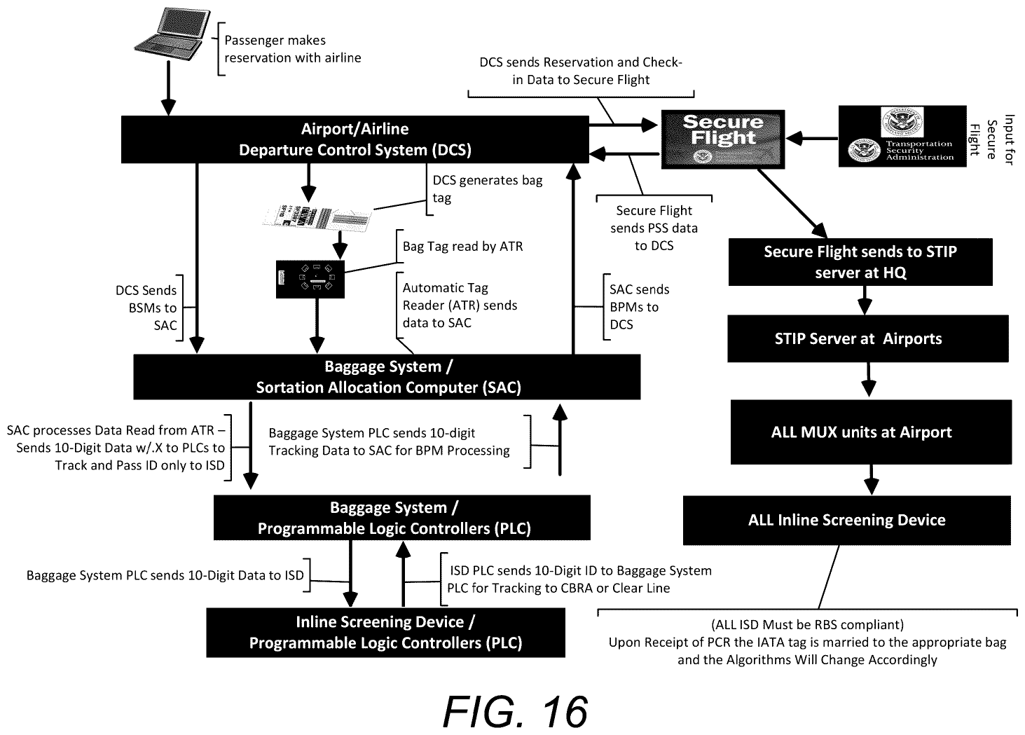

FIG. 14 is based on RP 1800 5.4.5, illustrating a Process Diagram “Reconciliation” which depicts the various components for connectivity with the DCA and ABS to support the process flow outlined below in FIG. 15 or 16. As outlined in RP 1800 5.4.7, Relevant message “Reconciliation,” the BSM, BPM, and BUM are components of the reconciliation process and play a role in the PBR process. These are primary examples of the capabilities outlined by IATA standards that IATA compliant or A4A compliant carriers can implement and deploy.

FIG. 15 illustrates a flow diagram of host reservation departure control system according to an embodiment. The notional flows in FIGS. 15 and 16 are meant to supply a high-level view of the assumed data flow between the DCS, ABS, and EDS networks. Each component and line of communication can be directly tied to an IATA Requirement and or Recommended Practice except for the PBR process specifics.

The PBR application can reside on an ABS Sortation Allocation Computer (SAC).

FIG. 16 illustrates a flow diagram of host reservation departure control system with STIP according to an embodiment.

There may be factors that exclude a bag from being eligible to fly without the passenger. These bags have already been flagged as defined within the IATA Resolution 745 Dangerous Goods in Passenger Bags as well as 745a and 745b as examples. Other factors which may affect the PBR process are RP 1745 where the IAA bag tag data may include the vetting status of TSA-PreCheck or other as well as Resolution 746, “Where two or more passengers. travelling as one party to a common destination or point of stopover by the same flight, present themselves and their baggage for travelling at the same time and place, they shall be permitted a total baggage allowance equal to the combination of their individual baggage allowances.”

The PBR functions enable reconciliation between a passenger and a bag. If PBR cannot recall an image based on its associated IATA bag tag, the carrier will be notified, and that bag is required to be offloaded pending the passenger's boarding status.

### PBR Function

The DCS shall relay the Passenger Name Record (PNR) and associated data to the PBR application for passengers that have failed to board. This should be done at an appropriate time before Flight Close Message (FCM) while allowing sufficient time to complete the full PBR process.

PBR will be initiated by the ABS controls systems at a predetermined time, e.g., 15 minutes prior to departure, or responsive to FCM being sent from the DCS. This function may require additional messaging between the DCS and ABS. This time setting is configurable.

The PBR workstation shall reside in a location convenient to TSA where additional staffing is not required. In an embodiment, if at DFW, the Central Monitoring Facility (CMF) is used.

In an embodiment, the PBR workstation is affixed adjacent to a security screening image workstation.

### Cleared Bag Process

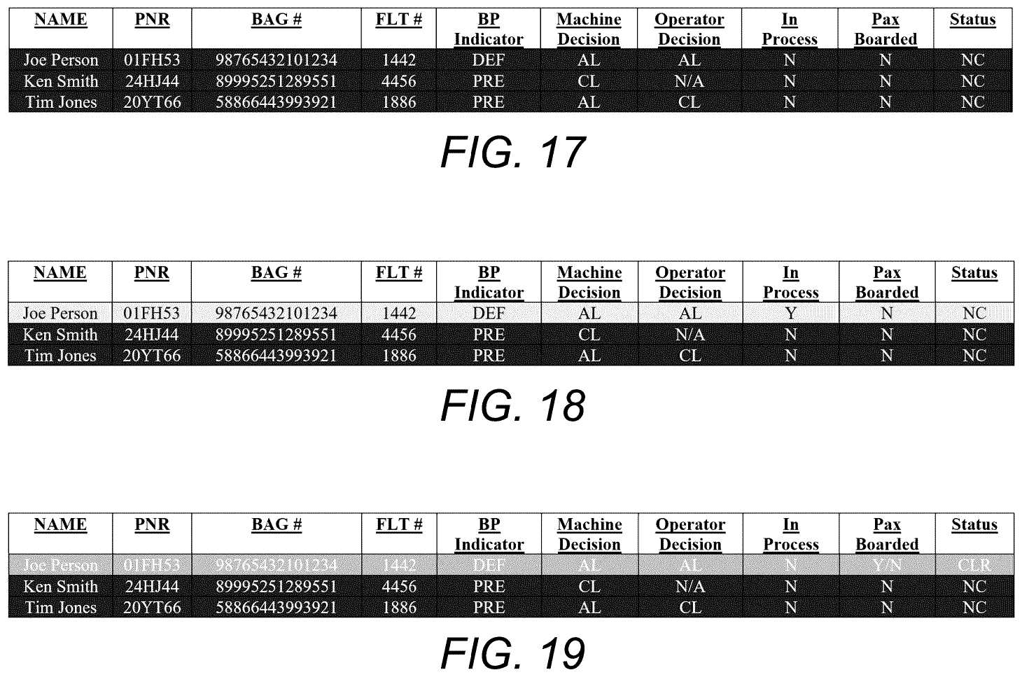

Upon initiating PBR for passengers deemed eligible, the PNR, bag tag number(s), and other associated screening information shall populate on a remote PBR screen as shown in the examples of FIGS. 17-22 and as set forth below. PBR eligible bags are initially displayed in a first color, such as BLUE, as shown in FIG. 17.

The TSO operating the PBR screen will select the first bag on the list, as illustrated in FIG. 18. Selecting the bag initiates the Bag Auto ID Transfer (BAIT) function where the image is automatically recalled on the Secondary Viewing Station (SVS), located adjacent to the PBR workstation, based on the IATA bag tag data. The BAIT process is in use for over 90% of inline screening. Embodiments described herein can utilize this same methodology for automatic image recall as part of the PBR process. As shown in FIG. 18, the associated passenger/bag information turns a second color, such as YELLOW, and the “In Process” indicator has changed from “N” to “Y.”

Upon review of the bag's image, where the TSO determines the bag to be CLEAR, the associated passenger/bag information transitions to a third color, such as GRAY, as shown in FIG. 19. The status indicator for the bag will change to “CLR” and the “In Process” indicator will change from “Y” to “N.” With this condition, no offloading is required for the selected bag, and BPM will be updated to reflect the bag is clear to fly without the passenger.

### Non-Clear Bag Process

The initial steps of the process for Non-CLEAR bags is similar to those described above, e.g., to display the bag and select the bag as described with respect to FIG. 17 and FIG. 18. Upon review of the bag's image, where the TSO determines the bag to be Non-CLEAR and requires a physical inspection, the associated passenger/bag information instead transitions to a fourth color, such as RED, as shown in FIG. 20. The status indicator will change to Offload Required, “OLR.” Offloading required and BPM are updated to reflect the bag is NOT clear to fly without the passenger. Alternately, the TSA agent can mark the bag as Non-CLEAR, and TSA will notify the carrier to offload the associated bag, or the BPM will be updated to reflect the bag is NOT clear to fly without the passenger.

Once the carrier has positively pulled the bag, the DCS will send the BUM to the ABS where the associated passenger/bag information transitions to a fifth color, such as BROWN, as indicated in FIG. 21. The status indicator will change to Pending “PEN”

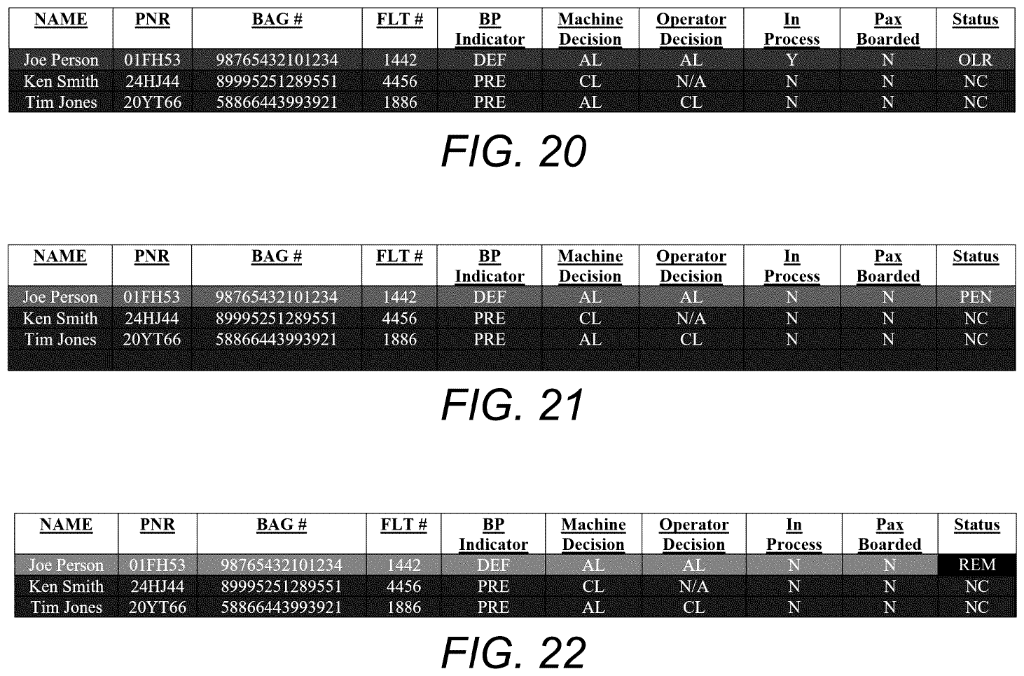

After the bag has been delivered to TSA for inspection, an additional inspection will be carried out. The additional inspection is according to the current policy set by TSA and agreed to by the carrier. In an embodiment, the carrier will be responsible for updating the BSM to reflect the bag has been cleared by TSA and can be handled by the carrier as needed. The carrier shall deliver the bag to TSA for additional inspection. The bag will be retained per TSA policy as agreed to with the carrier (Fly/No Fly). The associated passenger/bag information transitions to a sixth color, such as GREEN, as indicated in FIG. 22. The status indicator will change to REMOVED “REM” and the in-process “Y” indicator is updated to “N.”

Special Handling Considerations (Reference IATA RP 1745) can affect the handling of some passengers undergoing PBR screening processes. Passengers deemed to be traveling with a Selectee status as noted in the “x” element of the BSM will require special handling under the PBR process. Checked baggage associated with a selectee reservation will not be eligible for PBR due to risk level. Airline are prohibited from presenting selectee baggage. Any bag with a Selectee status will be directly routed to TSA's Checked Baggage Reconciliation Area (CBRA) for inspection regardless of disposition assigned by either the EDS or by OSARP. This is an instance where the TSA allows the baggage handling system controls to overwrite a clear bag disposition. When a Selectee bag arrives in CBRA, the Bag Status Display (BSD) will denote the status accordingly. Newer BSDs have been designed with a field to identify the passenger's flying statues. The field can indicate the passenger's flying status as follows: Clear (DEF)—Average traveler; Selectee (SEL)—Security Flagged; Known (PRE)—TSA pre check. Older BSDs may require adjustments such as modifying the color schemes to avoid rewriting the BSD software.

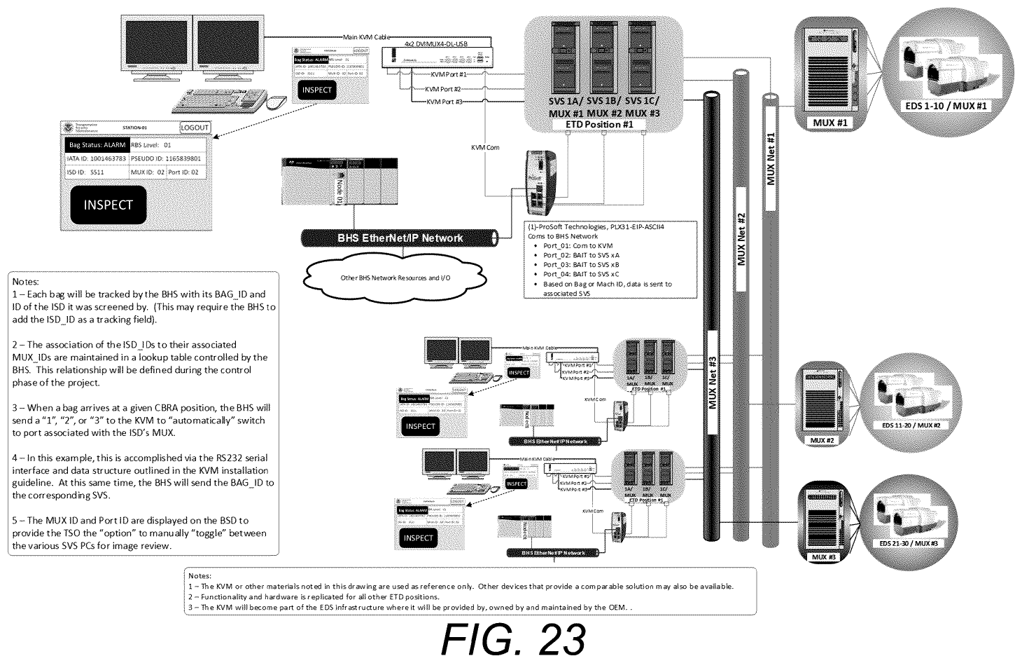

FIG. 23 illustrates an EDS network according to an embodiment. The illustrated configuration overcomes a challenge regarding physical limitations of the EDS network itself regarding Multiplexer (MUX) Limitations. Most airports have more than one “MUX.” The multiplexer is responsible for collecting images from each EDS and distributing them to the operator for onscreen inspection. This means that the images from a given MUX can be recalled on an SVS directly connected to that MUX. In other words, if a bag is screened in one terminal, a dedicated PBR for that terminal must be connected to that MUX. Hence, multiple PBR workstations may be required without further EDS Original Equipment Manufacturer (OEM) development. Alternatively, as illustrated in FIG. 23, the number of PBR workstations can be minimized by deploying the illustrated solution or similar (e.g., as deployed at Denver International Airport).

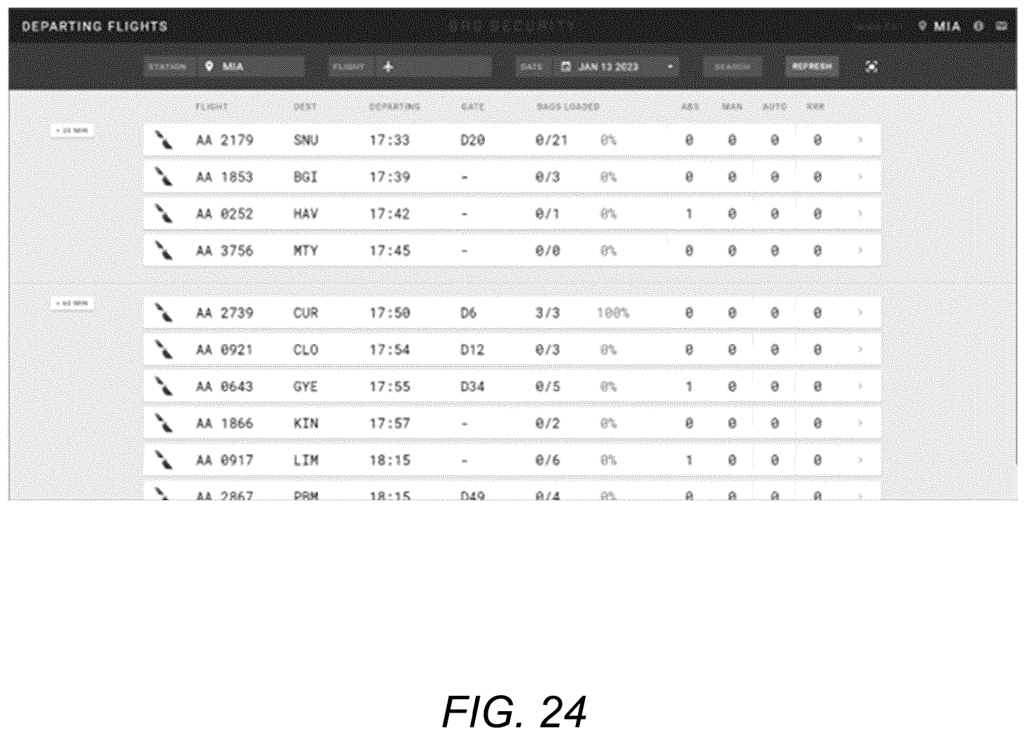

In an embodiment, the PBR process can be implemented as follows. As shown in FIG. 24, an airline agent or other designated individual responsible for international baggage reconciliation on each departing flight will review bags in an internal BRS software (such as Bag Security by American Airlines), e.g., bags that are showing in the “Bags On/Pax Not On” list. This review can be performed with a given time period remaining before departure, e.g., [insert designated time, such as 15] minutes prior to departure. FIG. 24 illustrates AA Bag Security Landing Page—AA Agent view.

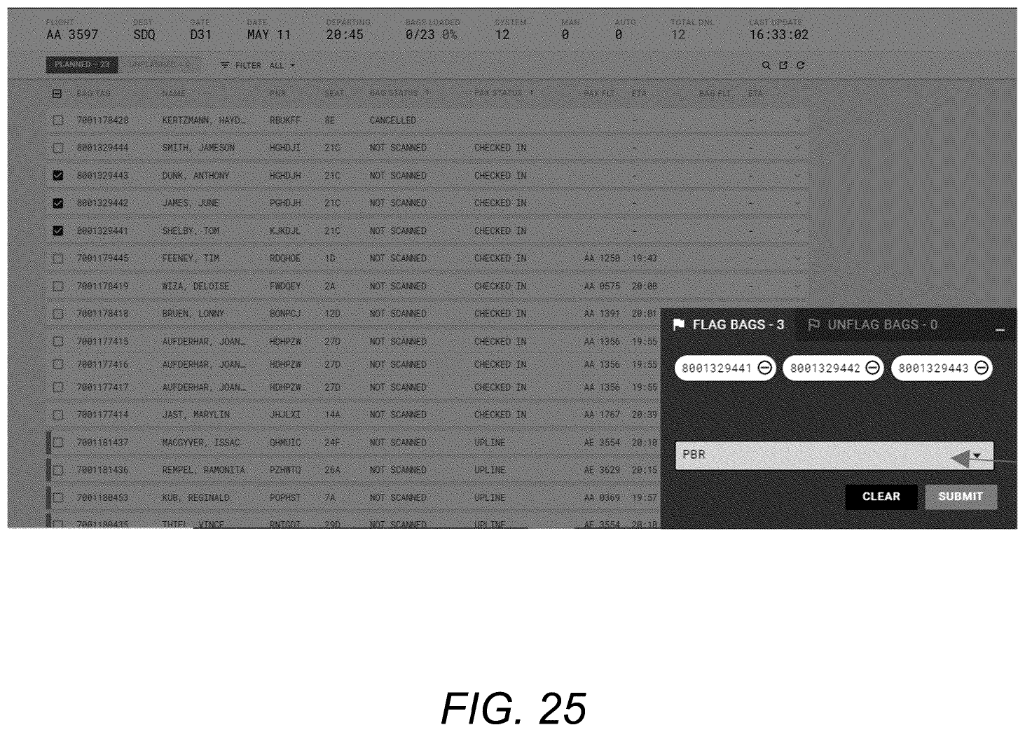

Next, bags are identified as being possible candidates, after taking into account the list of exceptions to the PBR process. Those candidates are selected in the BRS software as requiring PBR screening by TSA. As shown in FIG. 25, the agent can drill down to a specific flight drop down list, and add reason codes such as the indicated flagging to PBR. The agent can tag whether the bag is on-board or whether the passenger is not on-board. The bag security agent clicks on a bag(s) to flag, and selects the appropriate reason below (e.g., reason is PBR). The software can highlight the bag tag indication in yellow to indicate that the bag is flagged for PBR—TSA review.

Next, using BRS software, the agent will submit a list of the bags requiring PBR screening, which will be transmitted to the TSA agent conducting the screening electronically.

The TSA agent can enter the First Name/Last Name of who is on duty and will be reviewing the images and providing the disposition. The TSA agent accesses the list of bags requiring screening. In an embodiment, the TSA agent in the OSR room can use an airline-provided device, such as an airline-provided iPad, to visit a web URL such as PBR.AA.COM to bring up the list of bags on the airline-provided device. In an embodiment, the airline can require SSO authentication on the device, such as by having the agent use an ID code and passcode, or by entering their name or the like.

Next, the TSA agent will select a bag for screening which will display a bar code associated with the TSA image. The User can scan to retrieve the image of the bag in the TSA screening systems and conduct the screening.

Once a review of the screening image for a given bag is completed, the TSA agent will have three options for the bag which they can select-Cleared, No Image, and Not Cleared. Selecting an option will send the response back to Bag Security application, for the agents to review and action. Bags cleared by TSA will show a green bar or other indicator next to the tag number. A history record will indicate the bag was cleared. Bags not cleared will show red and indicate a “Do Not Load” bag. FIG. 9 illustrates a disposition history for a cleared bag according to an embodiment. FIG. 10 illustrates a disposition history for a not cleared bag, or a bag that has no image, according to an embodiment.

Next, the bag security application will show a cleared bag with a green bar or similar indicator next to the bag tag. No Image or Not Cleared bags will show with a red bar and will reflect in the history the bag was not cleared. The indication of Cleared will have a status Ok To Load. The indications of No Image or Not Approved, will have a status a Do Not Load. This will allow RampLink to display if the bag should or should not be displayed on the bag pull list to the ramp crew in addition to the response already displayed in Bag Security.

Next, the process repeats for the above steps of accessing the list of bags requiring screening, selecting a bag for screening via the bar code, reviewing the corresponding bag image to indicate a corresponding status of the bag, and showing a status of the bag on the bag security application and/or bag pull list. These steps can repeat for each bag that is submitted for PBR screening.

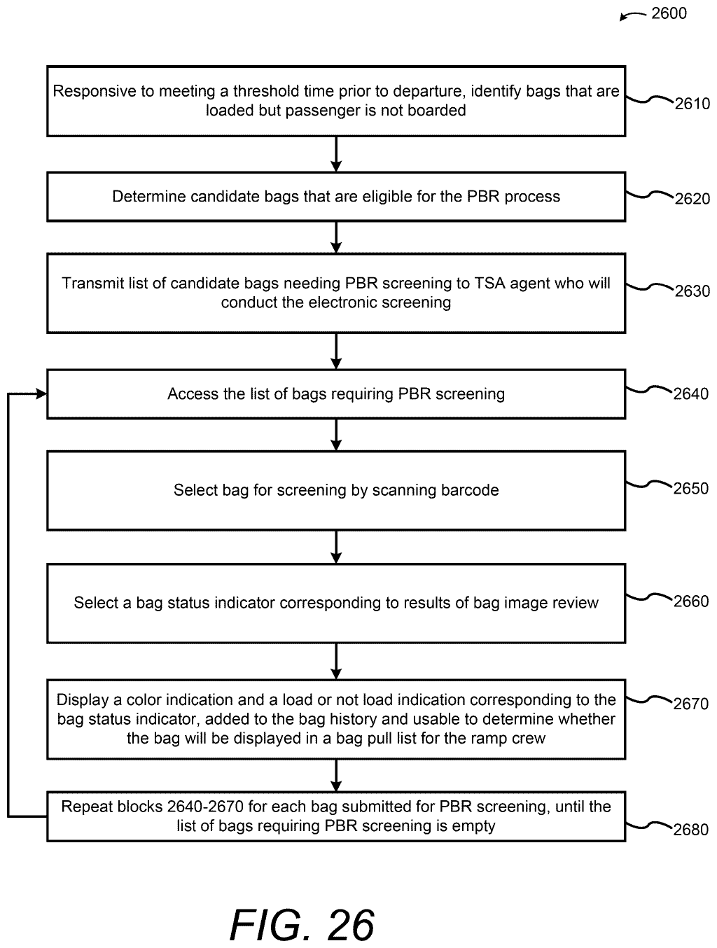

FIG. 26 illustrates a flowchart 2600 of the above steps of the PBR screening process according to an embodiment. In block 2610, responsive to meeting a threshold time prior to departure, it is identified that bags that are loaded but passenger is not boarded. In block 2620, candidate bags are determined that are eligible for the PBR screening. In block 2630, a list of candidate bags needing PBR screening is transmitted to a TSA agent who will conduct the electronic screening. For example, using bag security application. In block 2640, the list of bags requiring PBR screening is accessed. For example, using an airline-provided device. In block 2650, a bag is selected for screening by scanning barcode. In block 2660, a bag status indicator is selected corresponding to results of bag image review. In block 2670, a color indication and a load or not load indication is displayed corresponding to the bag status indicator, added to the bag history and usable to determine whether the bag will be displayed in a bag pull list for the ramp crew. In block 2680, blocks 2640-2670 are repeated for each bag submitted for PBR screening.

In an embodiment, the PBR screening process is performed in addition to the already existing PPBM logic that Bag Security utilizes, which already takes into account the passengers' boarded status and flagging of bags as Do Not Load by either manual or automatic means. The PBR process can provide various notifications, such as the following warning alerts:

Alert: Bag Security WARNING! Bag tag(s) [NUMBER] unable to be flagged because the passenger(s) already boarded the aircraft. Remove the passenger(s) from the aircraft to allow the bagtag to be flagged again. [OK, GOT IT]

Selectee bag restriction: Bag Security WARNING! Bag tag(s) [NUMBER] not eligible to be submitted for PBR process due to passenger TSA requirements. [OK, GOT IT]

Flight Not Allowed for the PBR Process (During the POC): Bag Security WARNING! Bag(s) in flight [NUMBER] not eligible to be submitted for PBR process. [OK, GOT IT]

Flagging Connecting Bags is not allowed (no image will be present for TSA): Bag Security WARNING! Connecting bag tag(s) [NUMBER] not eligible to be submitted for PBR process. [OK, GOT IT]

Bags not having pseudo ID: Bag Security WARNING! Bag tag(s) [NUMBER] not eligible for TSA process, because no TSA ID was sent from sortation. [OK, GOT IT]

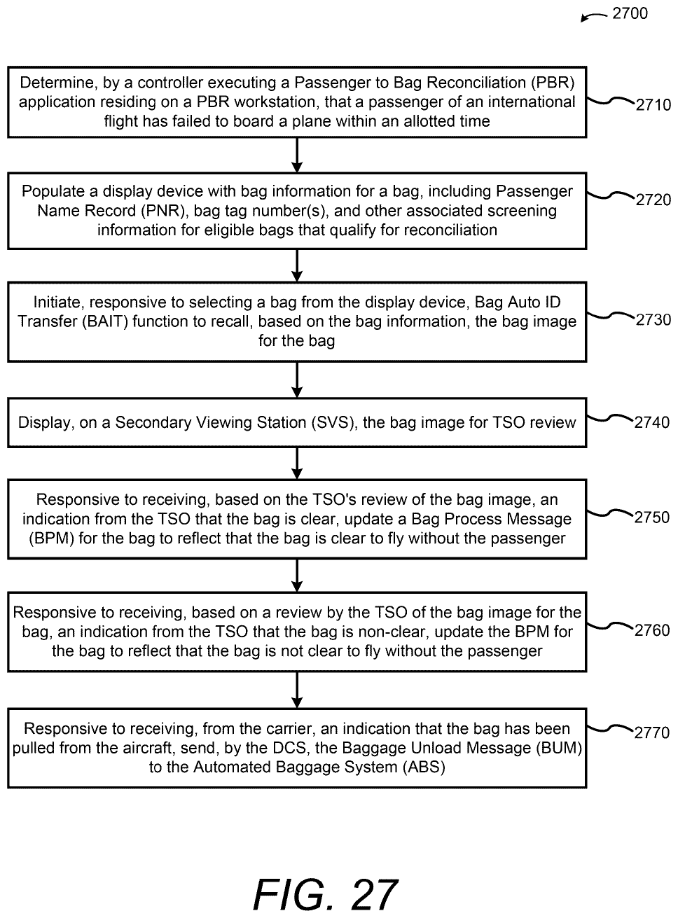

FIG. 27 illustrates a flowchart 2700 of a PBR screening process according to an embodiment. In block 2710, a controller executing a Passenger to Bag Reconciliation (PBR) application residing on a PBR workstation determines that a passenger of an international flight has failed to board a plane within an allotted time. In block 2720, a display device populates with bag information for a bag, including Passenger Name Record (PNR), bag tag number(s), and other associated screening information for eligible bags that qualify for reconciliation. In block 2730, responsive to selecting a bag from the display device, Bag Auto ID Transfer (BAIT) function is initiated to recall, based on the bag information, the bag image for the bag. In block 2740, a Secondary Viewing Station (SVS) displays the bag image for TSO review. In block 2750, responsive to receiving, based on the TSO's review of the bag image, an indication from the TSO that the bag is clear, a Bag Process Message (BPM) is updated for the bag to reflect that the bag is clear to fly without the passenger. In block 2760, responsive to receiving, based on a review by the TSO of the bag image for the bag, an indication from the TSO that the bag is non-clear, the BPM for the bag is updated to reflect that the bag is not clear to fly without the passenger. In block 2770, responsive to receiving, from the carrier, an indication that the bag has been pulled from the aircraft, the DCS sends the Baggage Unload Message (BUM) to the Automated Baggage System (ABS).

While a number of example embodiments of the present subject matter have been described, it should be appreciated that the present subject matter provides many applicable inventive concepts that can be embodied in a wide variety of ways. The example embodiments discussed herein are merely illustrative of ways to make and use the subject matter and are not intended to limit the scope of the claimed subject matter. Rather, as will be appreciated by one of skill in the art, the teachings and disclosures herein can be combined or rearranged with other portions of this disclosure and the knowledge of one of ordinary skill in the art.

Terms and phrases used in this document, unless otherwise expressly stated, should be construed as open ended as opposed to closed—e.g., the term “including” should be read as meaning “including, without limitation” or the like; the term “example” is used to provide example instances of the item in discussion, not an exhaustive or limiting list thereof; the terms “a” or should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Furthermore, the presence of broadening words and phrases such as “one or more,” “at least,” “but not limited to,” or other similar phrases, should not be read to mean that the narrower case is intended or required in instances where such broadening phrases may be absent. Any headers used are for convenience and should not be taken as limiting or restricting. Additionally, where this document refers to technologies that would be apparent or known to one of ordinary skill in the art, such technologies encompass those apparent or known to the skilled artisan now or at any time in the future.

What is claimed is:

1. A reconciliation system comprising:
a controller executing a Passenger to Bag Reconciliation (PBR) application residing on a display device to determine that a passenger of an international flight has failed to board a plane within an allotted time;
the display device further configured to:
populate a display device with bag information for a bag, including Passenger Name Record (PNR), bag tag number(s), and other associated screening information for eligible bags that qualify for reconciliation;
initiate, responsive to selecting a bag from the display device, Bag Auto ID Transfer (BAIT) function to recall, based on the bag information, a bag image for the bag;
a Secondary Viewing Station (SVS) configured to display the bag image that was recalled for TSO review;
the display device further configured to:
responsive to receiving, based on the TSO's review of the bag image, an indication from the TSO that the bag is clear, update a Bag Process Message (BPM) for the bag to reflect that the bag is clear to fly without the passenger;
responsive to receiving, based on a review by the TSO of the bag image for the bag, an indication from the TSO that the bag is non-clear, update the BPM for the bag to reflect that the bag is not clear to fly without the passenger; and
responsive to receiving, from a carrier, an indication that the bag has been pulled from an aircraft, send, by Departure Control System (DCS), a Baggage Unload Message (BUM) to an Automated Baggage System (ABS).

2. The reconciliation system of claim 1, further comprising a TSA workstation configured to scan, using a scan gun, a barcode displayed on the display device as part of the bag information, to read IATA bag tag data for the bag.

3. The reconciliation system of claim 1, wherein the bag image is a set of one or more computed tomography (CT) bag images obtained by an Explosive Detection System (EDS) when scanning the bag.

4. The reconciliation system of claim 1, wherein the SVS further comprises an Automated Baggage System (ABS) Sortation Allocation Computer (SAC).

5. The reconciliation system of claim 1, wherein the display device is further configured to display records of bags that are PBR eligible by designating such records with a blue color.

6. The reconciliation system of claim 1, wherein the display device is further configured to display records of bags whose bag images are undergoing TSO review by designating such records with a yellow color and an indication that the bag is in process of review by the TSO.

7. The reconciliation system of claim 1, wherein the display device is further configured to, responsive to receiving the indication from the TSO that the bag is clear, transition the bag record from yellow to gray, and update the bag record to set a bag status to clear and to set an in-process flag from Y to N.

8. The reconciliation system of claim 1, wherein the display device is further configured to, responsive to receiving the indication from the TSO that the bag is non-clear, transition the bag record from yellow to red, and update the bag record to set a bag status to offload required (OLR).

9. The reconciliation system of claim 1, wherein the display device is further configured to, responsive to receiving the indication from the carrier that the bag has been pulled, transition the bag record to brown, and update the bag record to set a bag status to pending (PEN).

10. The reconciliation system of claim 1, the display device being further configured to:
process, by the controller, a Passenger Name Record (PNR) and associated data received from DCS; and
determine, based on the PNR and associated data, that the passenger has failed to board within the allotted time corresponding to before a Flight Close Message (FCM) and before a deadline prior to departure corresponding to time to complete reconciliation.

11. The reconciliation system of claim 10, wherein the deadline defaults to 15 minutes prior to departure, and, upon receiving a Flight Close Message (FCM) from DCS, is dynamically set to the time of receiving the FCM.

12. The reconciliation system of claim 1, the display device being further configured to send, to the carrier, an indication that bags escalated to Non-CLEAR are required to be off-loaded and manually inspected by a TSA agent.

13. The reconciliation system of claim 1, the display device being further configured to, responsive to a failure to recall a bag image via the BAIT function, notify the carrier and require the bag to be offloaded pending a boarding status of the passenger.

14. The reconciliation system of claim 1, the display device being further configured to, responsive to receiving delivery of the bag pulled from the plane for additional inspection, transition the record of the bag to green, update the bag record to set a status to removed (REM), and update an in-process status from Y to N.

15. The reconciliation system of claim 1, wherein the Secondary Viewing Station (SVS) is located proximate to a PBR workstation, to enable the TSO to interact with the SVS and PBR workstation.

16. A method for reconciliation, comprising:
determining, by a controller executing a Passenger to Bag Reconciliation (PBR) application residing on a display device, that a passenger of an international flight has failed to board a plane within an allotted time;
populating the display device with bag information for a bag, including Passenger Name Record (PNR), bag tag number(s), and other associated screening information for eligible bags that qualify for reconciliation;
initiating, responsive to selecting a bag from the display device, Bag Auto ID Transfer (BAIT) function to recall, based on the bag information, a bag image for the bag;
displaying, on a Secondary Viewing Station (SVS), the bag image that was recalled for TSO review;
responsive to receiving, based on the TSO's review of the bag image, an indication from the TSO that the bag is clear, updating a Bag Process Message (BPM) for the bag to reflect that the bag is clear to fly without the passenger;
responsive to receiving, based on a review by the TSO of the bag image for the bag, an indication from the TSO that the bag is non-clear, updating the BPM for the bag to reflect that the bag is not clear to fly without the passenger; and
responsive to receiving, from a carrier, an indication that the bag has been pulled from an aircraft, sending, by Departure Control System (DCS), a Baggage Unload Message (BUM) to an Automated Baggage System (ABS).

17. The method of claim 16, wherein selecting a bag from the display device comprises scanning, using a scan gun, a barcode displayed on the display device as part of the bag information, to read IATA bag tag data for the bag.

18. The method of claim 16, wherein the bag image is a set of one or more computed tomography (CT) bag images obtained by an Explosive Detection System (EDS) when scanning the bag.

19. The method of claim 16, wherein the SVS further comprises a PBR workstation that is an Automated Baggage System (ABS) Sortation Allocation Computer (SAC).

20. The method of claim 16, further comprising displaying, on the display device, records of bags that are PBR eligible by designating such records with a blue color.

21. The method of claim 16, further comprising displaying, on the display device, records of bags whose bag images are undergoing TSO review by designating such records with a yellow color and an indication that the bag is in process of review by the TSO.

22. The method of claim 16, further comprising, responsive to receiving the indication from the TSO that the bag is clear, transitioning the bag record from yellow to gray, and updating the bag record to set a bag status to clear and to set an in-process flag from Y to N.

23. The method of claim 16, further comprising, responsive to receiving the indication from the TSO that the bag is non-clear, transitioning the bag record from yellow to red, and updating the bag record to set a bag status to offload required (OLR).

24. The method of claim 16, further comprising, responsive to receiving the indication from the carrier that the bag has been pulled, transitioning the bag record to brown, and updating the bag record to set a bag status to pending (PEN).

25. The method of claim 16, further comprising:
processing, by the controller, a Passenger Name Record (PNR) and associated data received from DCS; and
determining, based on the PNR and associated data, that the passenger has failed to board within the allotted time corresponding to before a Flight Close Message (FCM) and before a deadline prior to departure corresponding to time to complete the method for reconciliation.

26. The method of claim 25, wherein the deadline defaults to 15 minutes prior to departure, and, upon receiving a Flight Close Message (FCM) from DCS, is dynamically set to the time of receiving the FCM.

27. The method of claim 16, further comprising sending, to the carrier, an indication that bags escalated to Non-CLEAR are required to be off-loaded and manually inspected by a TSA agent.

28. The method of claim 16, further comprising, responsive to a failure to recall a bag image via the BAIT function, notifying the carrier and requiring the bag to be offloaded pending a boarding status of the passenger.

29. The method of claim 16, further comprising, responsive to receiving delivery of the bag pulled from the plane for additional inspection, transitioning the record of the bag to green, updating the bag record to set a status to removed (REM), and updating an in-process status from Y to N.

30. The method of claim 16, wherein the Secondary Viewing Station (SVS) is located proximate to a PBR workstation, to enable the TSO to interact with the SVS and PBR workstation.
